(19) United States
(12) Patent Application Publication
(10) Pub. No.: US 2007/0108309 A1
(43) Pub. Date: May 17, 2007

(54) Hydraulically driven pump-injector with hydromechanical locking device of nozzle needle for internal combustion engines

(76) Inventor: Boris Feinleib, Jerusalem (IL)

Correspondence Address: NATH & ASSOCIATES, 112 South West Street, Alexandria, VA, 22314, US

(21) Appl. No.: 11/587,490

(22) PCT Filed: Mar. 16, 2004
(86) PCT No.: PCT/IL04/00248

§ 371 Date: Oct. 26, 2006

(51) Int. Cl. F02M 47/02

(52) U.S. Cl. 239/88

(57) ABSTRACT

Hydraulically driven pump-injector for diesel engines with locking device of the nozzle needle in which diesel fuel is used as acting fluid, comprises: a body; a pressure intensifier; a return mechanism for piston and plunger; a distributing device, and a nozzle unit. An additional cylindrical cavity is made in pump-injector body in the area adjoining the nozzle, a rod being disposed in said additional cavity whose one face is set against the face of the needle; and the return spring of the nozzle needle being disposed between the rod and the face of said additional cavity. Said additional cavity is constantly connected with the accumulator of actuating fluid. As a result, the force acting on the nozzle needle face increases (approximately doubles) and the opening and the closing pressures of the nozzle needle increase accordingly, enabling an abrupt end of final injection phase and increasing the average injection pressure.

### TECHNICAL FIELD

The invention relates to the field of fuel supply systems for internal combustion engines, specifically to diesels and, more specifically, to their hydraulically driven pump-injectors and to conventional pump-injectors.

### BACKGROUND ART

In conventional fuel supply systems of diesel engines, locking of the nozzle needle in pump-injectors or in conventional injectors (hereinafter pump-injectors) is accomplished by seating, (and thus sealing) the nozzle needle on the locking cone of the nozzle body. The needle is seated on the cone at the end of the injection due to the force of the spring applied to the upper face of the needle. The spring force determines the speed of the needle seating which in turn determines the rate of EOI (End Of Injection). Numerous studies showed that the faster the EOI, the smaller is the part of the fuel delivered into the combustion chamber under low pressure at the final phase of the injection; as a result, better mixing formation are created in the combustion chamber, resulting in greater fuel efficiency and lower exhaust smoke emission, in particular PM.

When the seating (and sealing) force of the nozzle needle is not sufficient, the average injection pressure falls, which is not recommended for diesels with large bore cylinder diameters. Therefore, an attempt is usually made to increase the spring force acting on the nozzle needle. This is usually connected to the fact that an intermediate element (insert) must be installed between the pump-injector body and the nozzle body, having a precision connection with the pump-injector body and the nozzle body. In this case it seems possible to locate the return spring of the nozzle needle in the internal cavity of the insert. This allows for increasing the spring power, but does not completely solve the problem.

Thus, in conventional fuel systems, the spring force can be increased up to 40-50 kg allowing for the needle lift pressure of 350 Bar and needle closing pressure of 200 Bar, these values correspond to a needle diameter of 6 mm and the needle cross section differential coefficient of 0.6 (the ratio of the difference between the area of the needle cross-section and the area bounded by the circumference of the bearing edge of the needle cone to the needle cross-section area), (which is not enough considering the tendency to increasing maximum injection pressures to 2000-2500 Bar.)

In addition, adding an intermediate element (insert) increases the number of sealing high-pressure channels of the precisions joints and thus decreases the reliability and durability of the pump-injector.

Locking device of the needle in accordance with the invention allows for a considerable increase of the force acting on the needle during its seating, thus substantially increasing needle lift pressure, and also providing a faster and shorter EOI (End Of Injection) phase.

### DISCLOSURE OF INVENTION

In accordance with the invention, one of the drawbacks mentioned above, i.e. insufficient force acting on the upper face of the nozzle needle during the end of the injection phase, can be overcome by adding to the spring force acting on said face of the needle the force created by the pressure of the actuating fluid supplied to said face of the needle. It should be noted that the pressure of the actuating fluid in the hydraulically driven pump-injector is relatively high (200 Bar and more), and the force created by this pressure may considerably exceed the spring force (100-110 kg). Increasing the force acting on the needle also results in the increase in the needle lift (opening) to the range of 700 Bar, and the closing pressure to the range of 400 Bar, and, consequently, in the increase of the average injection pressure. All this improves the mixing formation in the combustion chamber, and ensures higher efficiency of the diesel engine. In addition, to avoid inserting an intermediate element between the pump-injector body and sprayer body, a rod is added to the system. Its one end is set against the nozzle needle face, and its second end is set against the pump-injector body during the upward movement of the nozzle needle and determines the value of the nozzle needle stroke. Installing the rod allows for increasing the reliability of the pump-injector by decreasing the number of precision joints from 2 to 1.

Pump-injector in accordance with the invention in which fuel is used as the actuating fluid comprises: a body with inlet and outlet channels connected with an accumulator (Rail) of actuating fluid, which is in turn connected to the actuating fluid pump, and a drain tank or sump, respectively; pressure intensifier, comprising a power piston and pumping plunger disposed in cylindrical cavities of said body, a working cavity being formed in pump-injector body above the power piston, and a drain cavity being formed under the piston connected through channel formed in the body with the drain tank; return mechanism of the power piston with pumping plunger comprising a spring with seat disposed in said body; a distributing device with a valve, predominantly having an electromagnetic drive controlled by an electronic control unit (the valve can also be controlled by piezoelectric, magnetostriction, mechanical or other devices) and periodically connecting the working cavity above the power piston with accumulator of actuating fluid and drain tank or sump through said inlet and outlet channels of pump-injector body; nozzle unit comprising a body and a locking (sealing) needle connected to the body by a tightening nut, additional cylindrical cavity being formed coaxially with the needle in said body of the pump-injector in the area adjoining the nozzle, the free face of the needle contacting said additional cavity, and a rod being disposed in the cavity, the lower face of the rod set against the face of the needle, and the upper face of the rod set against the face of said additional cavity when the needle with rod travels upward, and between the rod and the face of said additional cavity a return spring of the nozzle needle is disposed, said additional cavity being constantly connected through channel formed in pump-injector body with accumulator (Rail) of actuating fluid.

### SUMMARY OF THE INVENTION

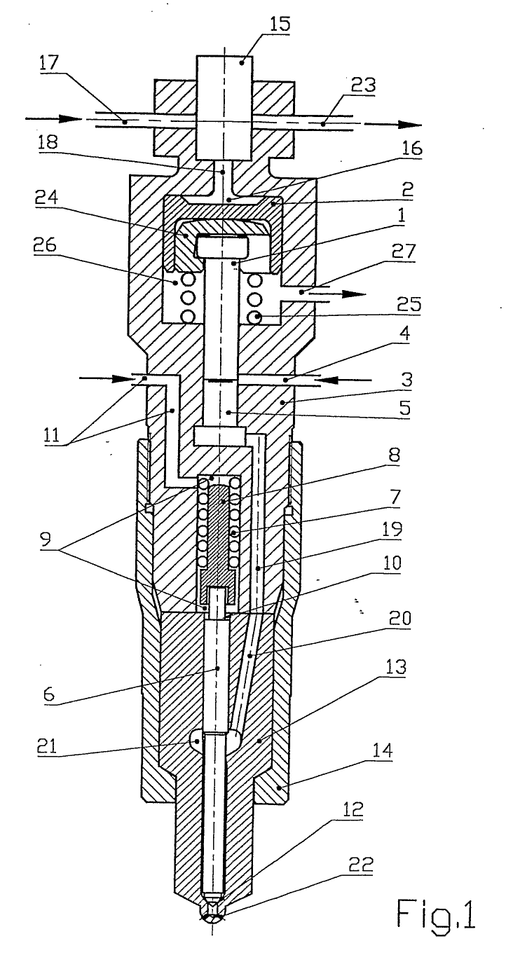

FIG. 1 shows a functional diagram of a hydraulically driven pump-injector in which fuel is used as the actuating fluid and in which the said fuel pressure increases the force acting upon the nozzle needle.

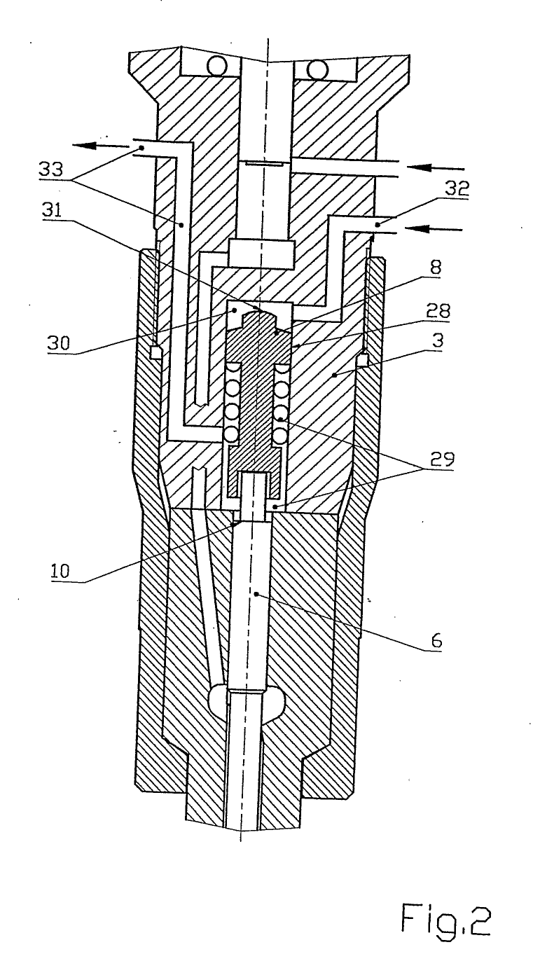

FIG. 2 shows a functional diagram of the locking device of the nozzle needle when oil is used as actuating fluid.

In FIG. 1: 1—pumping plunger; 2—power piston; 3—pump-injector body; 4—filling channel; 5—under-plunger cavity; 6—nozzle needle; 7—return spring of the nozzle needle; 8—rod of the nozzle needle; 9—additional cavity where spring 7 and rod 8 are disposed; 10—upper face of the nozzle needle; 11—channel, through which additional cavity 9 is connected with the source of the actuating fluid; 12—seat and sealing surface of the nozzle needle body 13; 13—nozzle needle body; 14—tightening nut connecting nozzle needle body 13 with body 3 of the pump-injector; 15—distributing device of the actuating fluid; 16—working cavity of power piston 2; 17—channel, through which the source of the actuating fluid is connected with the distributing device of the actuating fluid 15; 18—channel, connecting distributing device 15 with working cavity 16; 19, 20—communication channels in body 3 of the pump-injector and in body 13 of the nozzle, through which the under-plunger cavity is connected with the nozzle cavity; 21—pressure chamber; 22—injection orifice of the nozzle body; 23—outlet channel, connecting distributing device 15 with drain tank; 24—disk of the return spring; 25—return spring; 26—drain cavity under power piston 2; 27—channel, connecting drain cavity 26 with the drain tank

In FIG. 2: 28—precision joint of rod 8 and pump-injector body 3; 29—lower additional cavity, adjoining face 10 of the nozzle needle; 30—upper additional cavity, adjoining body 3 of the pump-injector; 31—upper face of rod 8; 32—channel connecting upper cavity 30 with the source of actuating fluid (oil); 33—channel connecting lower cavity 29 with the drain tank

Pump-injector according to FIG. 1 operates as follows:

When pumping plunger 1 with power piston 2 disposed in cylindrical cavities of pump-injector body 3 is at the extreme upper position, the fuel supplied from the accumulator (Rail) through channel 4 fills under-plunger cavity 5. At this time needle 6 due to the action of spring 7 through rod 8 disposed in additional cavity 9 of pump-injector body 3, combined with the pressure of the actuating fluid on face 10 of the needle, which is constantly supplied into said cavity 9 through channel 11 in body 3 of the pump-injector, is pressed towards the sealing surface 12 of nozzle body 13, connected with body 3 by tightening nut 14. When the electromagnet of the valve of distributing device 15 of the actuating fluid is energized, the valve opens, and working cavity 16 of power piston 2 through channels 17 and 18 is connected with the source of the actuating fluid (rail), the pressure in working cavity 16 increases; as a result, power piston 2 with pumping plunger 1 makes a working stroke. The pressure in under-plunger cavity 5 increases, and the fuel through channel 19 in pump-injector body 3 and channel 20 in the nozzle body under high pressure enters cavity 21 of the nozzle, acts on the differential cross sections of the needle and overcomes the force of spring 7 and pressure of the actuating fluid in cavity 9, and moves upward towards the extreme upper position; as a result, the fuel is injected through orifice 22 into the combustion chamber. When the electromagnet of the valve of distributing device of the actuating fluid 15 is de-energized, the valve closes, and working cavity 16 of power piston 2 through channels 18 and 23 is connected with the drain tank. The pressure in working cavity 16 and in under-plunger cavity 5 falls, and needle 6 of the nozzle is seated on sealing surface 12 of nozzle body 13 due to the action of the spring force 7 and the pressure of the actuating fluid in cavity 9, and the, injection stops. At the same time, due to the action of the return mechanism consisting of disk 24 and return spring 25, power piston 2 with pumping plunger 1 make the return stroke, during which power piston 2 expulses the actuating fluid through channel 23 into the drain tank. During the working stroke of power piston 2, the emulsion formed in drain cavity 26 as a result of the mixing of the fuel and air is expulsed into the drain tank through channel 27 in pump-injector body 3.

In pump-injector in accordance with the invention, volume fuel delivery is controlled by changing the duration of the electromagnetic signal fed to the electromagnet of the valve of distributing device 15.

### BEST MODE FOR CARRYING OUT OF THE INVENTION

The locking device of the nozzle needle in accordance with the invention should be preferably used in pump-injectors, in which fuel is used as actuating fluid which eventually is injected into the combustion chamber. In this case, as mentioned above, the actuating fluid (fuel) is supplied to the pump-injector under the pressure of around 200 Bar, which can be used for filling the additional cavity formed near the upper face of the nozzle needle, and for creating the additional force (in addition to the spring) acting on the upper face of the needle. However, the proposed locking device of the nozzle needle can also be used in hydraulically driven pump-injectors, in which oil is used as actuating fluid. In this case, actuating fluid, i.e. oil should be supplied to the additional cavity instead of the fuel. However, in this case fuel may get into the oil system of the diesel engine because of its leaking through a gap between the needle and body of the nozzle. In order to prevent the penetration of fuel into the oil (lubricating) system of the diesel engine, rod 8

(FIG. 2) must have precision mating surface 28 with body 3 of the pump-injector, in order to divide the additional cavity into two cavities: lower cavity 29, disposed between the face 10 of the needle 6 and lower face of rod 8, and upper cavity 30, disposed between upper face 31 of rod 8, and the face of body 3 of the pump-injector, said cavity 30 being connected through channel 32 with the source of the actuating fluid (oil), and said lower cavity 29 being connected through channel 33 with drain tank.

It will be evident to those skilled in the art that the invention is not limited to the details of the foregoing illustrated embodiments in part of summary and mode of invention and that the present invention may be embodied in other specific forms without departing from the spirit or essential attributes thereof The present embodiments are therefore to be considered in all respect as illustrative and not restrictive, the scope of the invention being indicated by the appended claims rather than by the foregoing description, and all changes which come within the meaning and range of equivalency of the claims are therefore intended to be embraced therein.

### INDUSTRIAL APPLICABILITY

It is more advisable to use the proposed locking device of the nozzle needle in a hydraulically driven pump-injector, because it has a source of the actuating fluid at relatively high pressure (around 200 Bar and higher), which can be used to supply the fluid required into additional cavity above the face of the nozzle needle and thus increase the force acting on the face of the needle, reduce the time needed for seating the needle, and increase the average pressure of the injection. As already mentioned, the latter is needed in large bore cylinder diesels and therefore the use of the locking device in accordance with the invention is especially advisable for such diesels (for instance, in heavy off roads, locomotives, marine applications and large power generation sets.).

Locking device of the nozzle needle in accordance with the invention can be also used in conventional fuel systems of separate type or in conventional pump-injectors with the plunger driven by a cam mechanism. In this case, the fluid (fuel or oil) should be supplied at increased pressure into said additional cavity from an autonomous source, which makes the design of the fuel system of the engine more complicated.

(In a system according to FIG. 1 it is also possible to create increased pressure in said additional cavity for locking the nozzle needle due to flowing of the fuel into said cavity through a gap between needle 6 and nozzle body 13.

I claim:

1. Hydromechanically driven pump-injector (pump-injector) with locking device of the nozzle needle for internal combustion engines predominantly for diesel engines,.in which fuel is used as actuating fluid (and which eventually is injected into the combustion chamber), comprises: a body with inlet and outlet channels connected with an accumulator (rail) of actuating fluid, which is in turn connected to the actuating fluid pump, and a drain tank or sump, respectively; pressure intensifier, comprising a power piston and pumping plunger, disposed in cylindrical cavities of said body, a working cavity being formed in pump-injector body above the power piston, and a drain cavity being formed under the piston and connected through a channel formed in the body with drain tank or sump; a return mechanism of the power piston with pumping plunger (for example, comprising a spring with seat disposed in said body); a distributing device with a valve, predominantly having an electromagnetic drive controlled by an electronic control unit (the valve can also be controlled by piezoelectric, magnetostriction, mechanical or other devices), periodically connecting the working cavity above the power piston with the accumulator of actuating fluid and drain tank or sump through said inlet and outlet channels of pump-injector body, respectively; a nozzle unit, comprising a body and a locking needle and connected to the body by means of a tightening nut; and an additional cylindrical cavity being formed in the pump-injector body in the area adjoining the nozzle coaxially with the needle, the upper face of the needle contacting said additional cavity, a rod being disposed in the cavity, the rod's lower face being set against the face of the needle, and its upper face being set against the face of said additional cavity when the needle with the rod travels upward, and a return spring of the nozzle needle being disposed between the rod and the face of said additional cavity, said additional cavity being constantly connected through a channel formed in the pump-injector body with the accumulator (rail) of the actuating fluid.

2. Pump-injector as in claim 1, wherein oil is used as the actuating fluid, said rod having a precision joint mating surface with the pump-injector body, dividing said additional cavity into two cavities: a lower cavity disposed between the face of the needle and the lower face of the rod, and an upper cavity disposed between the upper face of said rod and the pump-injector body, said lower cavity being constantly connected through the channel in the pump-injector body with the drain tank, and said upper cavity being constantly connected through the filling channel in the pump-injector body with the source of the actuating fluid (oil).
